(19) United States
(12) Patent Application Publication
(10) Pub. No.: US 2025/0251806 A1
(43) Pub. Date: Aug. 7, 2025

(54) INPUT DEVICE FOR HEAD-MOUNTABLE DEVICES

(71) Applicant: Apple Inc., Cupertino, CA (US)

(72) Inventor: Paul X. Wang, Cupertino, CA (US)

(21) Appl. No.: 18/435,965

(22) Filed: Feb. 7, 2024

(51) Int. Cl. G06F 3/041; G06F 3/01; H04R 1/10

(52) U.S. Cl. CPC G06F 3/041; G06F 3/016; H04R 1/1016

(57) ABSTRACT

An earbud includes a housing, a haptic driver carried by the housing, a haptic surface defined by the housing, and an input surface defined by the housing. The haptic surface is coupled to the haptic driver which is configured to generate a haptic output through the haptic surface in response to a haptic signal from a head-mountable device. The input surface is receptive to an input to transmit an input signal to the head-mountable device.

### FIELD

The present disclosure relates generally to electronic devices. More particularly, the present disclosures relate to communication between an input device and a head-mountable device.

### BACKGROUND

Recent advances in portable computing have enabled head-mountable devices that provide augmented reality and virtual reality (AR/VR) experiences to users. Such head-mountable devices can include various components such as a display, a viewing frame, lenses, optical components, a battery, motors, speakers, sensors, cameras, and other components. These components can operate together to provide an immersive user experience.

Users typically interact with and input text or commands to the head-mountable devices by using hand gestures and/or by speaking audible commands or phrases. These available text input methods, in lieu of a keyboard, can be cumbersome. Other methods of data input rely on using keyboards or other external electronic devices. However, even keyboards can be cumbersome and inconvenient for users to carry around. Therefore, there is a need for a device that allows the user to conveniently and accurately interact with a head-mountable device, particularly for text input.

### SUMMARY

In at least one example of the present disclosure, an earbud includes a housing, a haptic driver carried by the housing, a haptic surface defined by the housing, and an input surface defined by the housing. The haptic surface is coupled to the haptic driver which is configured to generate a haptic output through the haptic surface in response to receiving a haptic signal from a head-mountable device. The input surface is receptive to a tactile input to transmit an input signal to the head-mountable device.

In one example of the earbud, the haptic surface includes a portion of the input surface.

In one example of the earbud, the haptic driver is configured to generate a shear tactile output at the haptic surface.

In one example, the earbud further includes an audio driver.

In one example of the earbud, the audio driver includes a first haptic driver configured to generate a first haptic response in a first direction, and a second haptic driver configured to generate a second haptic response in a second direction different than the first direction.

In one example, the earbud further includes a processor and a memory device storing instructions that, when executed by the processor, cause the processor to convert the tactile input to a graphical representation signal used by the head-mountable device to display a graphical representation.

In one example, the earbud further includes a stylus sensor including at least one of an ultrasonic sensor, an optical flow sensor, or a capacitive sensor.

In at least one example of the present disclosure, a touch input system includes a first earbud including a first sensor and a second earbud including a second sensor. Upon arranging the first earbud and the second earbud on a support surface, the first earbud and the second earbud define a touch space adjacent to the support surface at which touch inputs are detectable via the first sensor and the second sensor.

In one example of the touch input system, the support surface includes an object surface.

In one example of the touch input system, the support surface includes a display of a client device.

In one example, the touch input system includes a case configured to receive the first earbud and the second earbud, the case further defining the touch space on the display of the client device.

In one example, the touch input system further includes a case configured to receive the first earbud and the second earbud. The case includes a third sensor.

In one example of the touch input system, the case includes a sensor configured to detect vibrations from the touch inputs at the touch space.

In one example of the touch input system, the first earbud, the second earbud, and the case are configured to determine a location of a touch input within the touch space.

In one example of the touch input system, each of the first earbud and the second earbud includes a fiducial.

In one example of the touch input system, the first earbud is attachable coupled to the second earbud to define a combined input surface.

In at least one example of the present disclosure, a wireless headphone includes an enclosure and an optical flow sensor carried by the enclosure. The optical flow sensor is configured to transmit sensor data to a display device to generate an image based on the sensor data.

In one example, the wireless headphone further includes a writing surface disposed on the enclosure adjacent to the optical flow sensor.

In one example, the wireless headphone further includes a speaker. The optical flow sensor is disposed at a distal end of the wireless headphone opposite the speaker.

In one example of the wireless headphone, the display device is a display of a head-mountable device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a system including an input device and a head-mountable device, according to one or more examples;

FIG. 2 illustrates a case to house an earbud, according to one or more examples;

FIG. 3 illustrates an earbud, according to one or more examples;

FIG. 4 illustrates fingers of the user's hand interacting with the earbud of FIG. 3, according to one or more examples;

FIG. 5 illustrates an earbud including an optical flow sensor, according to one or more examples;

FIG. 6 illustrates a touch input system including case on a support surface, according to one or more examples;

FIG. 7 illustrates a touch input system including a first earbud and a second earbud on a support surface, according to one or more examples;

FIG. 8 illustrates a touch input system in which the first earbud is configured to be coupled to the second earbud, according to one or more examples; and

FIG. 9 shows a high-level block diagram of an example computer system that can be used to implement examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to wearable devices. In particular, the following disclosure relates to wireless earbuds that can provide tactile input and output for wireless communication with head-mountable devices. In at least one example, an earbud can include a housing or other portion that can be at least partially disposed in, on, or otherwise in contact with a user's ear (or the area around a user's ear for bone-conduction). The earbud can include one or more electronic components disposed on or within the housing to operate the earbud. These components can include any components used by the earbud to produce audio (or in the case of bone conduction, sound waves or vibrations). For example, electronic components can include one or more speakers, audio drivers, transducers, microphones, processors, power supplies (e.g., batteries), circuitry components including wires, circuit boards, or any other electronic component used in the earbud to generate and output audio.

In at least one example, a head-mountable device can include a viewing frame and a securement arm (or strap/band) extending from the viewing frame. Examples of head-mountable electronic devices can include virtual reality or augmented reality devices that include an optical component. In the case of augmented reality devices, optical eyeglasses or frames can be worn on the head of a user such that optical windows, which can include transparent windows, lenses, or displays, can be positioned in front of the user's eyes. In another example, a virtual reality device can be worn on the head of a user such that a display screen is positioned in front of the user's eyes. The viewing frame can include a housing (e.g., a display housing or display frame) or other structural components supporting the optical components, for example lenses or display windows, or various electronic components.

Additionally, a head-mountable electronic device can include one or more electronic components used to operate the head-mountable electronic device. These components can include any components used by the head-mountable electronic device to produce a virtual or augmented reality experience. For example, electronic components of a head-mountable device can include one or more projectors, waveguides, speakers, processors, batteries, circuitry components including wires and circuit boards, or any other electronic components used in the head-mountable device to deliver augmented or virtual reality visuals, sounds, and other outputs. The various electronic components can be disposed within the electronic component housing. In some examples, the various electronic components can be disposed within or attached to one or more of the display frame, the electronic component housing, or the securement arm.

A user can interact with a conventional head-mountable device via audibly speaking, using hand gestures, or external keyboards or controls. Speaking or using hand gestures can be disruptive to nearby people. Transporting keyboards and controllers can also be cumbersome, bulky, and inconvenient. Additionally, many people carry wireless earbuds. However, wireless earbuds have heretofore included limited input functionality.

The following disclosure relates to an earbud which can receive haptic inputs and generate haptic outputs for wireless communication with a head-mountable device. Various types of haptic inputs and outputs can be implemented. In some examples, the earbud can provide a shear tactile output and/or receive a rotational or vibrational haptic input. For example, an earbud can include a housing, a haptic driver carried by the housing, a haptic surface defined by the housing, and an input surface defined by the housing. The haptic surface can be vibrationally coupled to the haptic driver which is configured to generate a haptic output through the haptic surface in response to a haptic signal from a head-mountable device. The input surface can receptive to a tactile input to transmit an input signal to the head-mountable device.

Earbuds of the present disclosure can also be implemented to define a touch space. A touch space can be real (i.e., with physical metes and bounds). In other examples a touch space can be virtual. To illustrate, a virtual touch space can include a virtual keyboard viewed through a head-mountable device. The virtual touch space (as seen through the head-mountable device) can be defined on a support surface, such as an object surface (e.g., a desk), a display of a client device (e.g., a monitor, tablet), etc. A case of the present disclosure can also be implemented in combination with one or more earbuds to define a touch space and to detect actuation with the touch space.

Other types of input methods are also herein contemplated. For example, an earbud can be utilized as a stylus that, upon interacting with a surface, generates an image for display at a head-mountable device. As another example, a combination (e.g., interlocking, mating, joining) of earbuds can be utilized as a controller for providing inputs to the head-mountable device.

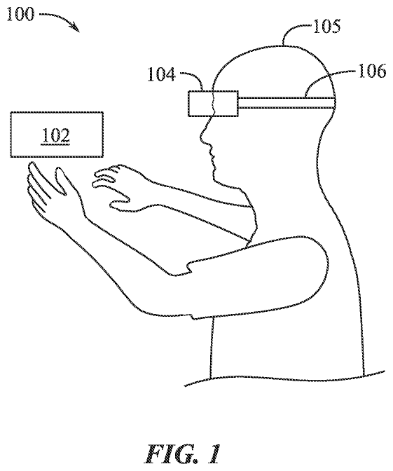

These and other examples are discussed below with reference to FIGS. 1-9. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a system 100 including an input device 102 and a head-mountable device 104 in accordance with one or more examples of the present disclosure. The head-mountable device 104 can be donned on a head 105 of a user. The input device 102 can be communicatively coupled to the head-mountable device 104. In other terms, signals and other communications can be wireless transmitted between the input device 102 and the head-mountable device 104.

As used herein, the term input device refers to an electronic device that can send and/or receive signals (whether via wired or wireless connections) from a head-mountable device. In particular examples, the input device includes an earbud. An earbud (or headphone) can include one or more devices that can generate audio (or vibrational signals perceivable as audio). For instance, earbuds or headphones can include various types of audio devices, including over-ear headphones, on-ear headphones, in-ear headphones or monitors, wireless headphones, wired headphones, noise-canceling headphones, bone conduction headphones, closed-back headphones, open-back headphones, semi-open headphones, waterproof headphones, DJ (disk jockey) headphones, etc. Earbuds can also include other audio devices, audio companion devices, or audio amplification devices such as hearing aids. The input device 102 can also be another type of electronic device or wearable device. In some other examples, rather than being an earbud, the input device 102 can be a smartwatch, a cellular phone or tablet device, a laptop, or other electronic device in communication with the head-mountable device 104.

While the present systems and methods are described in the context of a head-mountable device 104, the systems and methods can be used with any wearable apparatus, wearable electronic device, or any apparatus or system that can be physically attached to a user's body, but are particularly relevant to an electronic device worn on a user's head. The systems and methods can also be used with any electronic devices with one or more sensors capable of communicative coupling.

The head-mountable device 104 can include a display or other optical component (e.g., one or more optical lenses or display screens in front of the eyes of the user). In other words, the head-mountable device 104 can be a display device and can include a display. The display can include a screen for presenting augmented reality visualizations, a virtual reality visualization, or other suitable visualization. The display can be part of an optical module, which can include sensors, cameras, light emitting diodes, an optical housing, a cover glass, sensitive optical elements, etc. The head-mountable device 104 can include a display frame disposed around the display. The display can be disposed on or within the display frame. The display frame can be a display housing which houses the display and other optical components, such that the display is positioned within the display frame. For example, the display can be positioned within the display housing facing the user's face to display graphical information to the user.

The head-mountable device can include a strap or arms 106. The arms 106 can secure the head-mountable device 104 to the user's head. The arms 106 are connected to the display frame and extend distally toward the rear of the head. The arms 106 can to secure the display in a position relative to the user head (e.g., such that the display is maintained in front of a user's eyes). For example, the arms 106 extend over the user's ears. In certain examples, the arms 106 rest on the user's ears to secure the head-mountable device 104 via friction between each of the arms 106 and the user head. For example, the arms 106 can apply opposing pressures to the sides of the user head to secure the head-mountable device 104 to the user head.

The head-mountable device 104 can include a facial interface, such as a light seal or other foam extending about a perimeter and an inner surface of the display frame. As used herein, the term “facial interface” refers to a portion of the head-mountable device 104 that directly contacts and engages the user's face. For example the facial interface can be connected to the display frame (display housing). In particular, a facial interface includes portions of the head-mountable device 104 that conform to (e.g., compress against) regions of a user face. For example, a facial interface can include a pliant (or semi-pliant) face track that spans the forehead region, wraps around the eyes, contacts the zygoma region and the maxilla region of the face, and bridges the nose-. As used herein, the term “forehead region” refers to an area of a human face between the eyes and the scalp of a human. The term “zygoma region” refers to an area of a human face corresponding to the zygomatic bone structure of a human. The term “maxilla region” refers to an area of a human face corresponding to the maxilla bone structure of a human.

The facial interface can include various components forming a structure, webbing, cover, fabric, or frame of the display frame and the user skin. In particular implementations, a facial interface can include a seal (e.g., a light seal, environment seal, dust seal, air seal, etc.). It will be appreciated that the term “seal” can include partial seals or inhibitors, in addition to complete seals (e.g., a partial facial interface where some ambient light is blocked and a complete facial interface where all ambient light is blocked when the head-mountable device is donned). The facial interface can compress against the user's face to provide comfort and to block out ambient light from an ambient or external environment. As used herein, an “inner surface” refers to a surface of the head-mountable device 104 that is oriented to face towards (or contact) a human face or skin. By contrast, as used herein, an “outer surface” refers to an exterior surface of the head-mountable device 104 that outwardly faces the ambient environment.

The head-mountable device 104 can include an electronics pod (or electronics assembly). The electronics pod can be disposed on one of the arms 106. In some examples, the electronics pod can be disposed on the strap, the display frame, or elsewhere on the head-mountable device 104. The electronics pod can include various electronic components, such sensors, controllers, microcontrollers, processors, memory, batteries, power port, etc. At least some of the various electronic components can be communicatively coupled to the input device 102 (e.g., for generating an image for display that corresponds to an input signal from the input device 102).

In some examples, there can be multiple input devices 102, such as a pair of earbuds. In other words, there can be a first earbud and a second earbud. The first earbud can be placed in one ear of the user, while the second earbud can be placed in the other ear of the user. The first earbud can include a first sensor and the second earbud can include a second sensor. As will be described below, the earbud can include various additional sensors and means of output, such as audio drivers and haptic drivers. The earbud can be received by a case. The case can charge and store the earbud. The case can additionally include sensors and can be communicatively coupled to the head-mountable device 104.

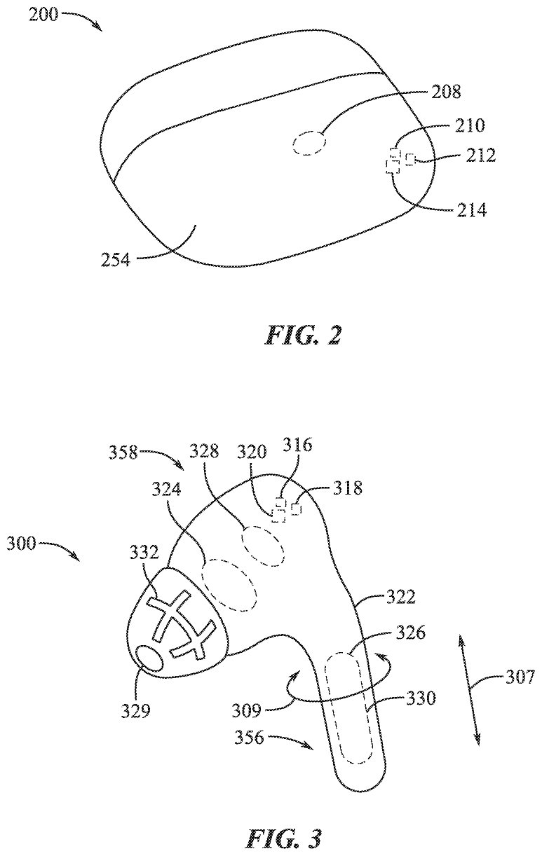

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Additional details of the case are described below in reference to FIG. 2.

FIG. 2 illustrates a case 200 in accordance with one or more examples of the present disclosure. In particular implementations, the case 200 is an example of the input device 102 discussed above in relation to FIG. 1. A case can include a guard, shell, cover, enclosure, pouch, charging pack, etc. for storing, charging, and/or protecting one or more electronic devices or input devices. In particular examples, the case 200 can house an earbud (examples of which are discussed above and also further below in relation to FIG. 3). For example, the case 200 can receive an earbud 300 (or a pair of earbuds 300).

As shown, the case 200 can include a button 208. The button 208 can be used for a variety of different types of inputs to a head-mountable device. In some examples, the button 208 can be used to confirm or make an input selection. To illustrate, the user can make visual selections on the head-mountable device by directing their gaze toward the desired selection. The user can then press the button 208 to confirm their visual selection.

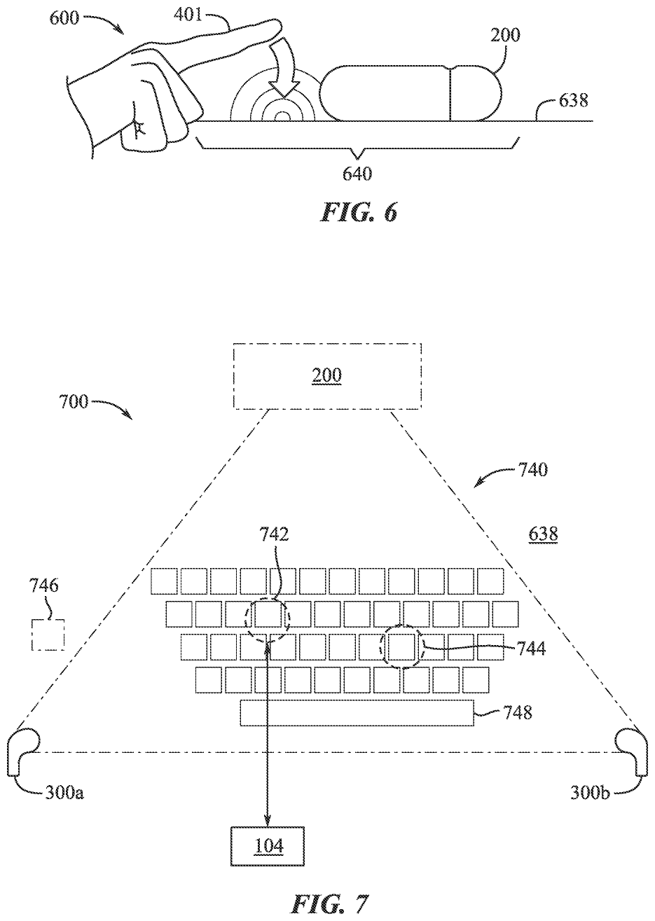

In some examples, the case 200 can include a sensor 210. The sensor 210 can include a camera, a vibration sensor, a microphone, a touch sensor (e.g., capacitive sensor, inductive sensor, resistive sensor, etc.). In some examples, the case 200 can include an inertial measurement unit (IMU) 212. In some examples, the case 200 can include additional sensors 214, including cameras, vibration sensors, microphones, etc. The sensor 210, the IMU 212, and/or the additional sensors 214 can detect inputs from the user, as will be further described in reference to FIG. 6.

In some examples, the case 200 can also include a surface (e.g., an external surface 254) which can include a touch surface to receive inputs from the user. In one example, the user can interact with the touch surface with theirs hand(s), by way of writing, swiping, tapping, or the like on the external surface 254 of the case.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Additional details of the earbud are described below in reference to FIG. 3.

FIG. 3 illustrates an earbud 300 in accordance with one or more examples of the present disclosure. As shown, the earbud 300 can include various elements that can detect haptic input and/or generate haptic output for use in communication with a head-mountable device. In particular examples, the earbud 300 can include a sensor 316, an IMU 318, and/or additional sensors 320. Each of the sensor 316, the IMU 318, and/or the additional sensors can be similar to the sensor 210, the IMU 212, and the additional sensors 214 of the case 200. For example, the sensor 316 can include a camera, a vibration sensor, a microphone, a touch sensor (e.g., capacitive sensor, inductive sensor, resistive sensor, etc.). The additional sensors 320, can include cameras, vibration sensors, microphones, etc. The sensor 316, the IMU 318, and/or the additional sensors 320 can further receive inputs from the user

The head-mountable device can receive input from the earbud 300 (as well as from the case 200). Additionally or alternatively, the head-mountable device can generate output based on input from the earbud 300 and/or the case 200. To illustrate, the earbud 300 can be used to receive inputs or commands from the user, which the earbud 300 can relay to the head-mountable device. Further, the earbud 300 can be used to both receive and output tactile information and audio from and to the user. To do so, the earbud 300 can include a haptic driver 324 carried by the housing 322. The housing 322 can include a cover which houses various electronic components, such as speakers, batteries, antennas, drivers (including the haptic driver 324), etc. of the earbud 300. The haptic driver 324 can include one or more linear and/or rotating actuators which can generate a vibration in a shear direction 307 or axial direction 309, respectively.

The earbud 300 can include a haptic surface 326 defined by the housing 322. As used herein, a haptic surface refers to a section of the housing 322 of the earbud 300 which can exhibit a haptic output. For example, when a user contacts and overlaps the haptic surface 326 with their finger, the user can feel the haptic output as a vibration, rumble, perceived surface movement (e.g., that mimics a mechanical displacement or button press), etc. In other words, the haptic surface 326 can be vibrationally coupled to the haptic driver 324 such that vibrational or other energy waves can travel from the haptic driver 324 to the haptic surface 326. The haptic driver 324 can generate a haptic output through the haptic surface 326 in response to a haptic signal (e.g., a digital message, computer-executable instruction, a data packet, etc. that, when processed, causes the haptic driver to generate a haptic output). In these or other examples, the head-mountable device can generate the haptic signal. Alternatively, a processor of the earbud 300 can generate the haptic signal.

In at least one example, the earbud 300 can include an audio driver 328. The audio driver 328 can generate an audible sound that can be output by a speaker 329 of the earbud 300. In some examples, the audio driver 328 can include a first haptic driver to generate a first haptic response in a first direction, and a second haptic driver to generate a second haptic response in a second direction different than the first direction. In other words, the audio driver 328 can generate an audio signal which is haptically received by the user. Additionally or alternatively, the audio driver 328 can receive a haptic signal from the user as an input audio signal. As described below, a first direction can include a shear direction (or longitudinal direction 307), while a second direction can include a rotational direction (or axial direction 309).

To cither input or output the haptic signal, the earbud 300 can include an input surface 330 defined by the housing 322. The input surface 330 can be receptive to a tactile input to transmit an input signal from the user's interaction with the earbud 300 to the head-mountable device. The input surface 330 can be an exterior surface of the earbud 300 over which, when the user places their finger, the user can provide a tactile input to the earbud 300 and thus communicate with the head-mountable device. The input surface 330 can at least partially coincide with a portion of the haptic surface 326. In this way, the user can both input information to the earbud 300 and receive output information (e.g., haptic feedback) from the earbud 300 at a localized region of the earbud 300. In these or other examples, the input surface 330 can correspond to a neck region 356 of the earbud 300, where a user can grasp or handle a portion of the earbud 300 extending outward relative to a body region 358. Additionally or alternatively, the input surface 330 can correspond to the body region 358 of the earbud 300, where the body region 358 is positioned adjacent the speaker 329.

In at least one example, the earbud 300 can be a first earbud which can be used in conjunction with a second earbud (not shown). Each of the first earbud and the second earbud can include a fiducial 332. As used herein, a fiducial can include a marking or other physical feature that can be used as a point of reference, a spatial locator, etc. when placed in a field of view of a camera or other sensor. The fiducial can include a color (such as white, or other bright color which is easily detectable in dark environments; or black, or other dark color which is easily detectable in bright environments). As further described below, fiducial markings of the earbud 300 can be used by the earbud 300 to help positionally correlate movements of the earbud 300 to accurate inputs for the head-mountable device.

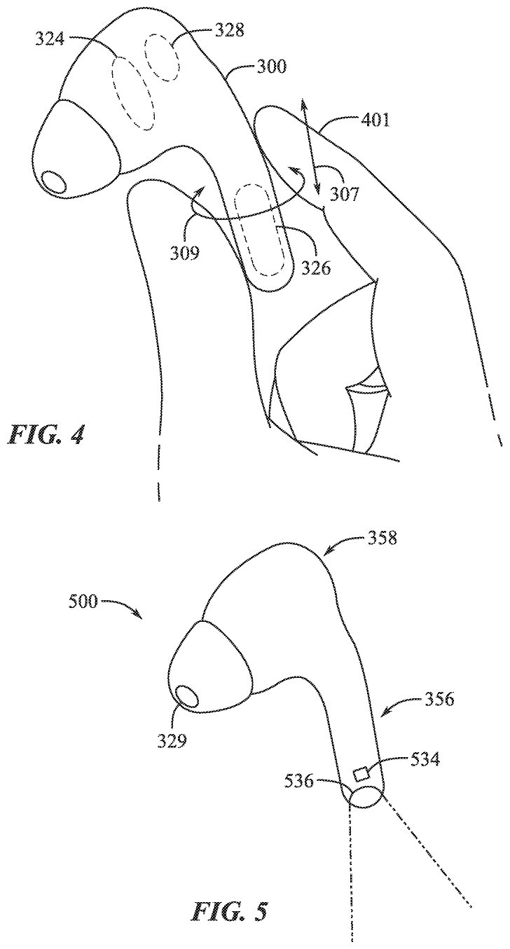

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Additional details of user interaction with the earbud are described below in reference to FIG. 4.

FIG. 4 illustrates fingers 401 of the user's hand interacting with the earbud 300 of FIG. 3 in accordance with one or more examples of the present disclosure. As discussed above, the haptic surface 326 can be a touch interface through which haptic inputs can be received by the earbud 300 and/or haptic outputs can be provided to the user's fingers 401. In some examples, the haptic surface 326 corresponds to a portion of the external surface of the earbud 300 that can be in direct contact with the user's fingers 401. In other examples, the haptic surface 326 is internal to the earbud 300 (e.g., subsurface to the exterior surface of the earbud 300). For instance, the haptic surface 326 can include an internal plate or other vibrational component that can mechanically generate the haptic response, which the user can experience as a tactile feedback. The haptic response can be a shear tactile output (e.g., in a longitudinal direction 307 along the earbud 300 or a shaft of the earbud 300), a rotational tactile output (e.g., in an axial direction 309 about the earbud 300 or about the shaft of the earbud 300), or a combination of a shear and rotational tactile output. In more detail, the shear tactile output according to some examples can include a series of vibrations that incrementally proceeds, extends further along, or translates in the direction 307. Likewise, the rotational tactile output according to some examples can include a series of vibrations that incrementally proceeds, extends further along, or translates in the direction 309.

In some examples, the haptic response can be generated by the audio driver 328. The audio driver 328 can include a first haptic driver to generate a first haptic response in a first direction, and a second haptic driver to generate a second haptic response in a second direction different than the first direction. Additionally or alternatively, the audio driver 328 can include the first haptic driver to receive a first haptic response in a first direction, and the second haptic driver to receive a second haptic response in a second direction different than the first direction.

In at least one example, the haptic driver 324 can generate a shear tactile output at the haptic surface 326. The shear tactile output can be generated by the haptic driver 324 and/or the audio driver 328. The user can hold or touch the earbud 300 at the haptic surface 326 and can feel the shear tactile output or the haptic response. The shear tactile output can communicate information from the head-mountable device to the user via the earbud. For example, the shear tactile output can indicate a status of the head-mountable device (power on, low battery, volume level, etc.).

In some examples, the input surface 330 can be receptive to a rotational tactile input. A rotational tactile input can be an input to the earbud 300 responsive to a rotational movement (e.g., a twist, slide, or turn) of one or more of the user's fingers along the axial direction 309 against a surface of the neck region 356 of the earbud 300. The rotational tactile input can be received by one or more of the sensor 316, the IMU 318, or other sensors 320. The user can hold or touch the earbud 300 at the input surface 330 and can move or rotate their fingers against and relative to the input surface 330 to communicate information to the head-mountable device. For example, the user cause the head-mountable device to be powered on/off, adjust volume, adjust brightness of a display of the head-mountable device, etc.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Additional details of user interaction with the earbud are described below in reference to FIG. 5.

FIG. 5 illustrates an earbud 500 including an optical flow sensor 534 in accordance with one or more examples of the present disclosure. Although not all components are shown or labeled, the earbud 500 can be substantially similar to and include some or all of the components and features of the earbud 300 of FIG. 3. For example, the earbud 500 can include the housing 322, or an enclosure, and the optical flow sensor 534 can be carried by the enclosure.

Additionally, the earbud 500 can include the speaker 329. The optical flow sensor 534 can be located at a distal end of the earbud 500 (e.g., wireless headphone) opposite the speaker 329. Specifically, the speaker 329 can be located near a proximal end of the earbud 500, which can be inserted into the user's ear. The optical flow sensor 534 can be located at the opposite end of the earbud 500 (e.g., furthest from the user's ear).

The optical flow sensor 534 can be a stylus sensor including an ultrasonic sensor, an optical flow sensor, or a capacitive sensor. In some examples, the optical flow sensor 534 or the stylus sensor can include an ultrasonic sensor, a capacitive sensor, a resistive sensor, an inductive sensor, an accelerometer, a gyroscope, or other types of sensors.

The optical flow sensor 534 can transmit sensor data to a display device to generate an image based on the sensor data. The display device can include a head-mountable device, a cellular device, a laptop, etc. The sensor data can include any data collected by the optical flow sensor 534. In some examples, the user can use the earbud 500 as a stylus to write or draw text to be rendered at the display device. In some examples, the optical flow sensor 534 can detect a light level of the ambient environment. Additionally or alternatively, the optical flow sensor 534 can detect changes of a detected surface topography (e.g., of an object surface) to accurately correlate with movement or displacement of the earbud 500 as a stylus. Thus, as the earbud 500 is manipulated (e.g., to write text, draw, make a selection within a touch space, etc.), the optical flow sensor 534 can transmit sensor data to a processor of the earbud 500—which in turn relays the sensor data to a head-mountable device (or other client device) for generating a visual output of the earbud stylus movement.

The earbud 500 can include a writing surface 536 disposed on the enclosure or the housing 322 adjacent to the optical flow sensor 534. The writing surface 536 can be a lens or other protective cover that is transparent to optical and/or infrared wavelengths. In other examples, the writing surface 536 is optically opaque and therefore defines a field of view of the optical flow sensor 534. The writing surface 536 can contact various surfaces when the user is virtually writing with the earbud 500. For example, the writing surface 536 can contact and glide along a table surface, a paper surface, a device display surface, etc.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Details of a touch input system are described below in reference to FIG. 6.

FIG. 6 illustrates a touch input system 600 in accordance with one or more examples of the present disclosure. As shown, the touch input system 600 can include the case 200 disposed on a support surface 638. The support surface 638 can include a variety of surfaces upon which the case 200 can be positioned, stored, or set. In some examples, the support surface 638 can include a table top, the ground, countertop, device display surface (e.g., a monitor, screen, etc.), or any other suitable surface which can physically support the case 200. The support surface 638 can be an object surface on which the case 200 can be placed.

The case 200 can define a touch space 640 on or adjacent to the support surface 638. The touch space 640 can be defined as a region within which the user can interact with the case 200. In one example, the touch space 640 can be a region centered on the case 200. In one example, the touch space 640 can be defined by a region that is within a threshold distance from the case 200. The touch space 640 can be predetermined by the user. For example, the user can increase or decrease the threshold distance, as desired.

In at least one example, the sensor 210, the IMU 212, or other sensors 214 can detect vibrations from the user providing touch inputs (e.g., tapping, thumping, knocking, etc.) to the support surface 638 within the touch space 640. It will also be appreciated that the sensor 210, the IMU 212, or other sensors 214 can detect a pattern or series of touch inputs that represent a particular type of input or correspond to a given meaning (e.g., two taps for “yes,” one tap for “no”). In at least one example, the sensor 210 or the other sensors 214 can detect motion of the user's hands or fingers within the touch space 640. The case 200 can generate sensor data for the head-mountable device based on the user's actions within the touch space 640. The case 200 can reject other interactions with the support surface 638 outside of the touch space 640. For example, the case 200 can reject ambient vibrations, tapping or typing from nearby persons other than the user, etc.

In at least one example, a surface of the case 200 defines an additional touch space receptive to touch inputs and vibrational inputs. In addition to being receptive to vibrations and taps within the touch space 640, the surface of the case 200 can be receptive to touch inputs (e.g., via sensors, such as capacitive sensors, resistive sensors, inductive sensors, etc.). In some examples, this can allow the user to utilize more than one type of input method (e.g., in combination or simultaneously).

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Details of additional touch input systems are described below in reference to FIG. 7.

FIG. 7 illustrates a touch input system 700 in accordance with one or more examples of the present disclosure. As shown, the touch input system 700 can include a first earbud 300a and a second earbud 300b disposed on the support surface 638. The touch input system 700 can include the first earbud 300a including a first sensor, such as any of the sensor 316, the IMU 318, or additional sensors 320. The touch input system 700 can also include the second earbud 300b including a second sensor, such as any of the sensor 316, the IMU 318, or additional sensors 320.

Upon arranging the first earbud and the second earbud on the support surface 638, the first earbud 300a and the second earbud 300b can define a touch space 740 on a support surface at which touch inputs can be detectable via the first sensor and the second sensor.

In at least one example, the touch input system 700 can include the case 200. The case 200 can receive, store, charge, etc. the first earbud 300a and the second earbud 300b. The case 200 can also include a third sensor such as such as any of the sensor 316, the IMU 318, or additional sensors 320. The case 200 can further define the touch space 740. For example, the case 200 can extend or expand the touch space 740. In specific examples, the case 200 can more accurately define the metes and bounds (whether real or virtual) of the touch space 240 by providing an additional reference point, boundary point, etc.

The touch inputs can include vibrations, taps, or motions by the user at the support surface 638 within the touch space 740. The first earbud 300a, the second earbud 300b, and the case 200 can determine a location of a touch input within the touch space 740. A first touch input can correspond to a first location 742 on the support surface 638 within the touch space 740 while a second touch input can correspond to a second location 744, different from the first location 742, on the support surface 638 within the touch space 740. Based on the first location 742 of the first touch input, the touch input system 700 send a first command or input to the head-mountable device. Based on the second location 744 of the first touch input, the touch input system 700 send a second command or input to the head-mountable device. Taps or vibrations can occur outside of the touch space 740, such as at a third location 746. The touch input system 700 can reject such taps.

In some examples, the support surface 638 can include a display 748 of a client device. In these or other examples, the display 748 include a graphical representation (e.g., an image of a keyboard, a screen with icons, an image, digital content, an application or game, etc.). The display 748 can, in particular examples, be a virtual display which is seen from the viewpoint of the user through the head-mountable device (e.g., in a mixed-reality experience) as being projected onto the support surface 638. In such an example, the device can display a background screen, home screen, blank screen, etc. that is visually conducive (and not distracting or confusing) for providing touch inputs to the virtual display 748. Alternatively, no head-mountable device or virtual display is involved. Rather, the display 748 can be an actual display of a keyboard, icon arrangement, controller configuration, etc. that is rendered by a client device. Thus, even non-touch screen devices (which are not designed to receive touch inputs at the display) can be converted to receive touch inputs via the touch input system 700. That is, via the touch input system 700, touch inputs can be accurately correlated with visual images or graphical content depicted at the display of the client device.

In the example depicted in FIG. 7, the display 748 includes a keyboard. The touch input system 700 can input text to the head-mountable device based on determining a touch input at the first location 742, a touch input at the second location 744, and additional touch inputs at further locations. Although depicted as a keyboard, in other examples, the display 748 can include software application screens, games, etc.

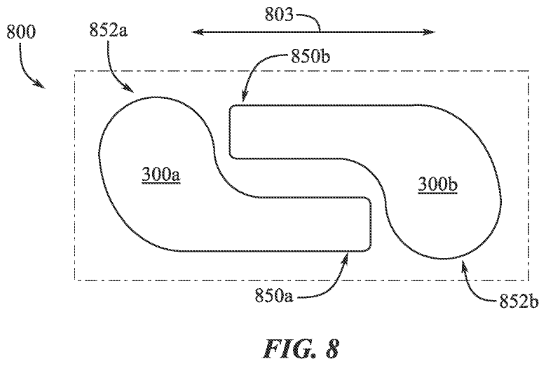

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7. Details of additional touch input systems are described below in reference to FIG. 8.

FIG. 8 illustrates a touch input system 800 in accordance with one or more examples of the present disclosure. As shown, the touch input system 800 can include the first earbud 300a and the second earbud 300b joined together to form a combined interface, controller, etc. In certain examples, the first earbud 300a and the second earbud 300b are stacked at least partially on top of each other. In other examples, the first earbud 300a and the second earbud 300b are positioned laterally adjacent to each other. In these or other examples, the touch input system 800 can provide increased surface area to provide a wider variety of touch inputs or be used in various different applications. In one example, the touch input system 800 can be configured as a stylus (similarly described with reference to FIG. 5). In one example, the touch input system 800 can define a surface that can receive touch inputs from the user.

In one example, the first earbud 300a and the second earbud 300b can be coupled such that a distal end 850a of the first earbud 300a is proximate to a proximal end 852b of the second earbud 300b, and a proximal end 852a of the first earbud 300a is proximate to a distal end 850b of the second earbud 300b. The coupling mechanism can include magnetic coupling or mechanical coupling (such as via snap-fit connections, grooves and rails, etc.). In some examples, the first earbud 300a can be moved laterally, along direction 803, relative to the second earbud 300b to adjust the surface area. As used herein, the proximal ends refer to the ends of the earbud that are placed in the user's ears, while the distal ends refer to opposite ends of the earbud and are furthest from the user's ears.

In some examples of the touch input system 800, one or both of the first earbud 300a and the second earbud 300b can be further coupled to other auxiliary devices, such as the case 200, or docking stations, etc. For example, a docking station can allow input surfaces of the first earbud 300a and the second earbud 300b to be increased.

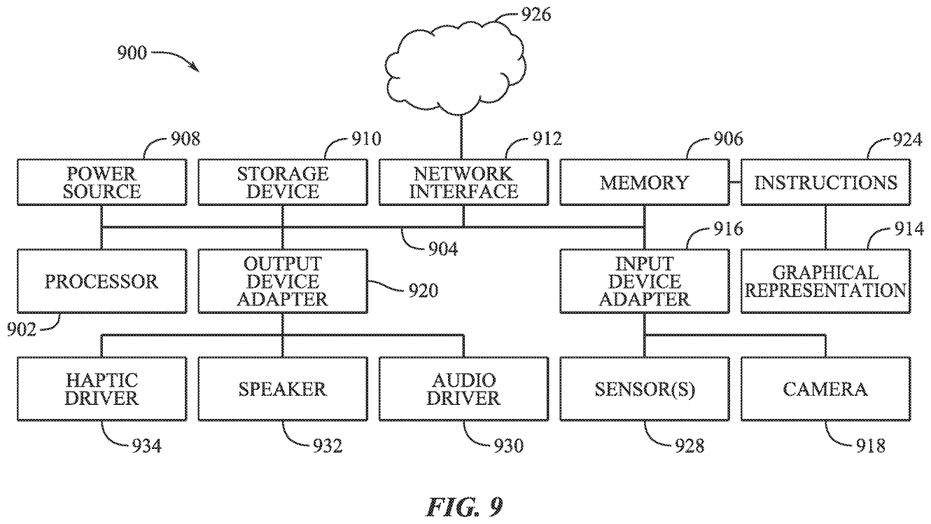

Any of the features, components, and/or parts, including the arrangements and configurations thereof shown in FIG. 8 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Details of computer systems for implementing tactile input and output are described below in reference to FIG. 9.

FIG. 9 shows a high-level block diagram of a computer system 900 that can be used to implement examples of the present disclosure. In various examples, the computer system 900 can include various sets and subsets of the components shown in FIG. 9. Thus, FIG. 9 shows a variety of components that can be included in various combinations and subsets based on the operations and functions performed by the computer system 900 in different examples. In at least one example, the computer system 900 can be part of the head-mountable device 104, the case 200, or the earbud 102, 300, or 500 described above in connection with FIGS. 1-8. It is noted that, when described or recited herein, the use of the articles such as “a” or “an” is not considered to be limiting to only one, but instead is intended to mean one or more unless otherwise specifically noted herein.

The computer system 900 can include a central processing unit (CPU) or processor 902 connected via a bus 904 for electrical communication to a memory device 906, a power source 908, an electronic storage device 910, a network interface 912, an input device adapter 916, an output device adapter 920, and a display. For example, one or more of these components can be connected to each other via a substrate (e.g., a printed circuit board (PCB) or other substrate) supporting the bus 904 and other electrical connectors providing electrical communication between the components. The bus 904 can include a communication mechanism for communicating information between various parts of the computer system 900.

The processor 902 can be a microprocessor or similar device can receive and execute a set of instructions 924 stored by the memory device 906. The memory device 906 can be referred to as main memory, such as random access memory (RAM) or another dynamic electronic storage device for storing information and instructions to be executed by the processor 902. The memory device 906 can also be used for storing temporary variables or other intermediate information during execution of instructions executed by the processor 902. The processor 902 can include one or more processors or controllers, such as, for example, a CPU for the processor 902 or the head-mountable device 104, the case 200, or the earbud 102, 300, or 500 in general and a touch controller or similar sensor or input/output (I/O) interface used for controlling and receiving signals from the display or speaker 932 and any other sensors being used. The power source 908 can include a power supply capable of providing power to the processor 902 and other components connected to the bus 904, such as a connection to an electrical utility grid or a battery system.

The storage device 910 can include read-only memory (ROM) or another type of static storage device coupled to the bus 904 for storing static or long-term (i.e., non-dynamic) information and instructions for the processor 902. For example, the storage device 910 can comprise a magnetic or optical disk (e.g., hard disk drive (HDD)), solid state memory (e.g., a solid state disk (SSD)), or a comparable device.

The instructions 924 can include information for executing processes and methods using components, such as the processor 902, of the computer system 900. Such processes and methods can include, for example, the methods described in connection with other examples elsewhere herein for generating predicted dictations. In at least one example, the memory device 906 can store instructions that, when executed by the processor 902, cause the processor 902 to convert tactile input to a graphical representation signal (e.g., computer-executable instructions, a data packet, etc.) used by the head-mountable device to display a graphical representation. In at least one example, the graphical representation can include a text input.

The network interface 912 can comprise an adapter for connecting the system 900 to an external device via a wired or wireless connection. For example, the network interface 912 can provide a connection to a computer network 926 such as a cellular network, the Internet, a local area network (LAN), a separate device capable of wireless communication with the network interface 912, other external devices or network locations, and combinations thereof. In one example, the network interface 912 is a wireless networking adapter which can connect via WI-FI(R), BLUETOOTH(R), Bluetooth Low-Energy (BLE), Bluetooth mesh, or a related wireless communications protocol to another device having interface capability using the same protocol. In some examples, a network device or set of network devices in the network 926 can be considered part of the computer system 900. In some cases, a network device can be considered connected to, but not a part of, the computer system 900.

The input device adapter 916 can provide the computer system 900 with connectivity to various input devices such as, for example, cameras 810, sensors 928, and other external electronic device components, such as touch input devices, a keyboard, or other peripheral input device, related devices, and combinations thereof. One or more sensors, which can include any of the sensors of input devices described herein, can be used to detect physical phenomena in the vicinity of the computing system 900 (e.g., light, sound waves, electric fields, forces, vibrations, etc.) and convert those phenomena to electrical signals. In some examples, the input device adapter 916 can be connected to a stylus or other input tool, whether by a wired connection or by a wireless connection (e.g., via the network interface 912) to receive input.

The output device adapter 920 can provide the computer system 900 with the ability to output information to a user, such as by providing visual output using one or more display, by providing audible output using one or more speakers 932, audio drivers 930, audio output devices, or providing haptic feedback sensed by touch via one or more haptic drivers 934. Other output devices can also be used. The processor 902 can control the output device adapter 920 to provide information to a user via the output devices connected to the adapter 920.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. An earbud, comprising:
a housing;
a haptic driver carried by the housing;
a haptic surface defined by the housing and coupled to the haptic driver, the haptic driver configured to generate a haptic output through the haptic surface in response to receiving a haptic signal from a head-mountable device; and
an input surface defined by the housing, the input surface receptive to an input to transmit an input signal to the head-mountable device.

2. The earbud of claim 1, wherein the haptic surface comprises a portion of the input surface.

3. The earbud of claim 1, wherein the haptic driver is configured to generate a shear tactile output at the haptic surface.

4. The earbud of claim 1, further comprising an audio driver.

5. The earbud of claim 4, wherein the audio driver includes a first haptic driver configured to generate a first haptic response in a first direction, and a second haptic driver configured to generate a second haptic response in a second direction different than the first direction.

6. The earbud of claim 1, further comprising:
a processor; and
a memory device storing instructions that, when executed by the processor, cause the processor to convert the input to a graphical representation signal used by the head-mountable device to display a graphical representation.

7. The earbud of claim 1, further comprising a stylus sensor including at least one of an ultrasonic sensor, an optical flow sensor, or a capacitive sensor.

8. A touch input system, comprising:
a first earbud including a first sensor; and
a second earbud including a second sensor;
wherein upon arranging the first earbud and the second earbud on a support surface, the first earbud and the second earbud define a touch space adjacent to the support surface at which touch inputs are detectable via the first sensor and the second sensor.

9. The touch input system of claim 8, wherein the support surface comprises an object surface.

10. The touch input system of claim 8, wherein the support surface comprises a display of a client device.

11. The touch input system of claim 10, further comprising a case configured to receive the first earbud and the second earbud;
wherein the case further defines the touch space on the display of the client device.

12. The touch input system of claim 8, further comprising a case configured to receive the first earbud and the second earbud, the case including a third sensor.

13. The touch input system of claim 12, wherein the case comprises a sensor configured to detect vibrations from the touch inputs at the touch space.

14. The touch input system of claim 11, wherein the first earbud, the second earbud, and the case are configured to determine a location of a touch input within the touch space.

15. The touch input system of claim 8, wherein each of the first earbud and the second earbud includes a fiducial.

16. The touch input system of claim 8, wherein the first earbud is attachable to the second earbud to define a combined input surface.

17. A wireless headphone, comprising:
an enclosure; and
an optical flow sensor carried by the enclosure;
wherein the optical flow sensor is configured to transmit sensor data to a display device to generate an image based on the sensor data.

18. The wireless headphone of claim 17, further comprising a writing surface disposed on the enclosure adjacent to the optical flow sensor.

19. The wireless headphone of claim 17, further comprising a speaker;
wherein the optical flow sensor is disposed at a distal end of the wireless headphone opposite the speaker.

20. The wireless headphone of claim 17, wherein the display device comprises a display of a head-mountable device.
